(19) United States
(12) Patent Application Publication
(10) Pub. No.: US 2023/0218111 A1
(43) Pub. Date: Jul. 13, 2023

(54) GRILL DEVICES WITH ACCESSORY RAIL ASSEMBLIES, AND RELATED ACCESSORIES

(71) Applicant: Traeger Pellet Grills, LLC, Salt Lake City, UT (US)

(72) Inventors: Matthew G. Czach, Kalamazoo, MI (US); Kevin Alexander, Salt Lake City, UT (US); Katarzyna Sutherland, Park City, UT (US); Patrick Fratesi, Salt Lake City, UT (US); Joseph Dieudonne Morin, Springville, UT (US); Bradley T. Smith, South Elgin, IL (US)

(21) Appl. No.: 18/154,315

(22) Filed: Jan. 13, 2023

Related U.S. Application Data
(60) Provisional application No. 63/266,762, filed on Jan. 13, 2022.

(51) Int. Cl. A47J 37/07; F24B 1/20

(52) U.S. Cl. CPC A47J 37/0786; F24B 1/20; A47J 37/0704

(57) ABSTRACT

A grill device may include an accessory rail assembly including at least one accessory rail. Each accessory rail may include an upper flange, a lower flange, and a web extending between and connected to the upper flange and the lower flange. Additionally, a plurality of brackets may connect the web to a cooking portion assembly of the grill device. An accessory may include at least one attachment structure. The attachment structure may include an upper feature sized and shaped to wrap around and conform to a portion of a surface of an upper flange of an accessory rail, and a lower feature sized and shaped to wrap around and conform to a portion of a surface of a lower flange of the accessory rail. A shelf accessory may include a shelf, a first bracket, and a second bracket.

### PRIORITY CLAIM

This application claims the benefit of the filing date of U.S. Provisional Patent Application Ser. No. 63/266,762, filed Jan. 13, 2022, for “GRILL DEVICES WITH ACCESSORY RAIL ASSEMBLIES, AND RELATED ACCESSORIES,” the disclosure of which is hereby incorporated herein in its entirety by this reference.

### TECHNICAL FIELD

This disclosure relates generally to grill devices, components thereof, and related accessories. In particular, the disclosure relates to grill devices having accessory rail assemblies for customizable accessory configurations, and related accessories.

### BACKGROUND

Grills and smokers have long been used to prepare food and perform other tasks. For example, grills and smokers are often used to prepare meats, vegetables, fruits, and other types of food. Typical grills and smokers are intended for outdoor use, due to the byproducts of combusting fuel and the smoke created during the cooking and/or smoking of food that may make them unsuitable for use indoors. Accordingly, grills and smokers are typically located and used outdoors, away from the kitchen. Due to the remote location from the kitchen, it may be inconvenient to keep cooking implements, such as spatulas, forks, tongs, and the like in the kitchen during use of the smoker or grill. Likewise, it may not be feasible to utilize kitchen counters for preparation of food and/or for performing tasks such as transferring food into and out of a cooking compartment of an outdoor grill. Thus there are a number of challenges and problems associated with outdoor grills and smokers that need to be addressed.

### SUMMARY

Some embodiments include a grill device including an accessory rail assembly with at least one accessory rail. The accessory rail may include an upper flange, a lower flange, and a web extending between and connected to the upper flange and the lower flange. Additionally, a plurality of brackets may connect the web to a cooking portion assembly of the grill device.

Additional embodiments include an accessory for a grill device that includes at least one attachment structure. The attachment structure may include an upper feature sized and shaped to wrap around and conform to a portion of a surface of an upper flange of an accessory rail of a grill device. The attachment structure may additionally include a lower feature sized and shaped to wrap around and conform to a portion of a surface of a lower flange of the accessory rail.

In further embodiments, a shelf accessory for a grill device may include a shelf, a first bracket, and a second bracket. The first bracket may be coupled to a first end of the shelf and may include a slot sized and configured for attachment to an accessory rail assembly of a grill device and a leg extending to a foot located and configured to rest against a cooking portion assembly of the grill device. The second bracket may be coupled to a second end of the shelf and may include a slot sized and configured for attachment to an accessory rail assembly of a grill device and a leg extending to a foot located and configured to rest against the cooking portion assembly of the grill device.

### BRIEF DESCRIPTION OF THE DRAWINGS

For a detailed understanding of the present disclosure, reference should be made to the following detailed description, taken in conjunction with the accompanying drawings, in which like elements have generally been designated with like numerals, and wherein:

FIG. 1 shows an isometric view of a grill device with an accessory rail assembly according to an embodiment of the present disclosure;

FIG. 2 shows an isometric view of an accessory rail of the accessory rail assembly of FIG. 1;

FIG. 3 shows an isometric view of a hook accessory according to an embodiment of the present disclosure;

FIG. 4 shows an isometric view of a roll holder accessory according to an embodiment of the present disclosure;

FIG. 5 shows an isometric view of a basket accessory according to an embodiment of the present disclosure;

FIG. 6 shows an isometric view of a shelf accessory according to an embodiment of the present disclosure;

FIG. 7 shows an isometric view of a bracket of the shelf accessory of FIG. 6;

FIG. 8 shows an isometric view of a clip of the shelf accessory of FIG. 6.

### DETAILED DESCRIPTION

The illustrations presented herein are not actual views of any grill, wood-pellet grill, or any component thereof, but are merely idealized representations, which are employed to describe embodiments of the present invention.

As used herein, the singular forms following “a,” “an,” and “the” are intended to include the plural forms as well, unless the context clearly indicates otherwise.

As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded.

As used herein, any relational term, such as “first,” “second,” “top,” “bottom,” “upper,” “lower,” “above,” “beneath,” “side,” “upward,” “downward,” etc., is used for clarity and convenience in understanding the disclosure and accompanying drawings, and does not connote or depend on any specific preference or order, except where the context clearly indicates otherwise. For example, these terms may refer to an orientation of elements of a grill device tem when utilized in a conventional manner. Furthermore, these terms may refer to an orientation of elements of a grill device as illustrated in the drawings.

As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.).

As used herein, the term “grill device” means a grilling and/or smoking device used to grill and/or smoke food. Particularly, the grill devices described herein may be outdoor grill devices configured for grilling and/or smoking food in outdoor environments.

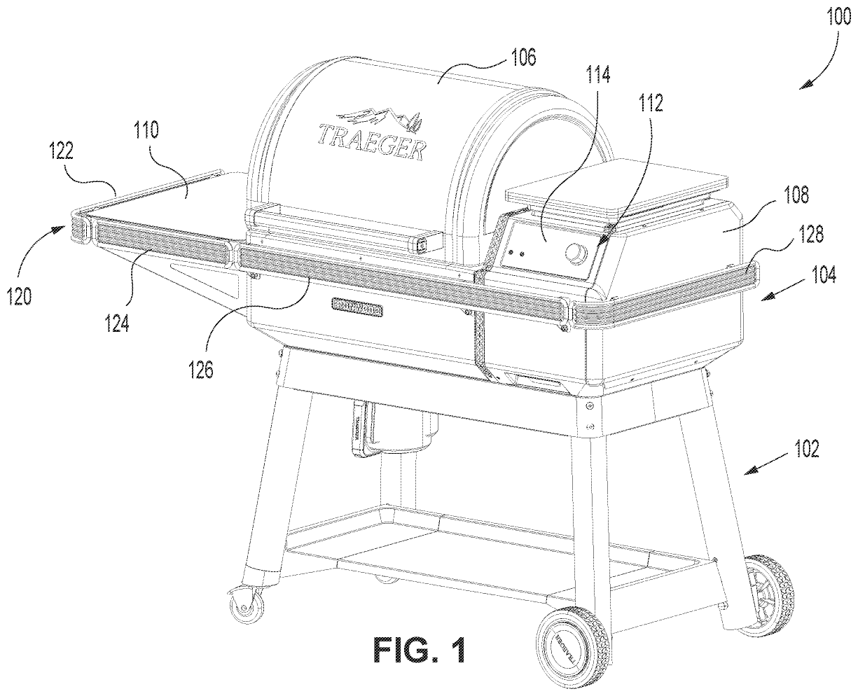

FIG. 1 shows an isometric view of a grill device 100 according to one or more embodiments of the present disclosure. As shown in FIG. 1, the grill device 100 may include a base assembly 102, and a cooking portion assembly 104. The cooking portion assembly 104 may be disposed on the base assembly 102.

The cooking portion assembly 104 may include a lid 106 covering a cooking chamber, which may have one or more cooking racks therein. The cooking portion assembly 104 may include a fuel chamber 108 (e.g., a wood pellet hopper). The cooking portion assembly may additionally include a fixed shelf 110, opposite the fuel chamber 108.

In some embodiments, a controller 112 may be at least partially disposed in a housing of the fuel chamber 108. The controller 112 may control a cooking temperature of the grill, control fuel feed rates, control cooking cycles and processes, control fuel burn rates, monitor ambient temperature, monitor internal and external temperatures, monitor fuel levels, monitor grease and ash levels, monitor position of the lid 106, monitor flame presence and levels, control ignition processes, and/or perform other functions.

In some embodiments, the controller 112 may include a display 114 for presenting information to a user present a display to a user. For example, the display 114 may be visible from an exterior of the grill device 100. The display 114 may show a variety of operating information and may display one or more graphical user interfaces (GUIs) that allows interaction from user.

In some embodiments, the controller 112 includes a transmitter and a receiver configured to communicate information to and from a remote location, such as a mobile device and/or a computer (e.g. a personal computer, a server computer, or the cloud). The controller. The controller 112 may be configured to transmit information, such as sensor readings, alerts, etc., to the remote location and to receive information, such as temperature set points, control cycles, etc., from the remote location.

Referring still to FIG. 1, in some embodiments, the grill device 100 may include a wood-pellet grill. For example, the grill device 100 may utilize wood pellets that are fed to an igniter and fire pot assembly to produce heat and smoke for cooking and preparing food products. In additional embodiments, the grill device 100 may include a charcoal smoker. In further embodiments, the grill device 100 may include a combination of a wood-pellet grill and a charcoal smoker. In yet further embodiments, the grill device 100 may include a gas grill. For instance, the grill device 100 may utilize natural gas and/or propane to produce heat for cooking and preparing food products. In some embodiments, the grill device 100 may include both a wood-pellet grill and a gas grill. For instance, the grill device 100 may utilize wood-pellets and/or gas to heat, cook, and prepare food products. As a non-limiting example, the grill device 100 may include any conventional gas system utilized on grills. For purposed of the present application, the grill device 100 is described as a wood-pellet grill. However, the systems and components described herein are applicable to any of the grills described herein, and all of the above-described grills are within the scope of the present disclosure.

An accessory rail assembly 120 may extend along at least a portion of the cooking portion assembly 104 of the grill device 100. For example, and as shown in FIG. 1, the accessory rail assembly 120 may comprise a plurality of accessory rails 122, 124, 126, 128 that together extend along substantially the entire perimeter of a first end, a front, and a second end of the cooking portion assembly 104 of the grill device 100.

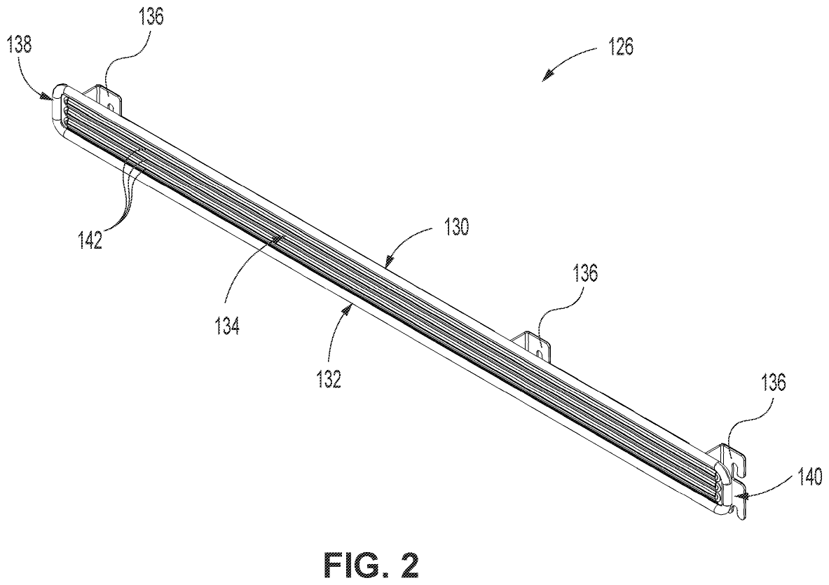

The accessory rail 126 is shown in FIG. 2 and will be described as an example accessory rail, each of the accessory rails 122, 124, 126, 128 of the accessory rail assembly 120 may have a similar construction. The accessory rail 126 is comprised of an upper flange 130, a lower flange 132, a web 134, and brackets 136. The brackets 136 may be configured to secure the accessory rail 126 to the grill device 100. The brackets 136 may be secured to one or more of the upper flange 130, lower flange 132, and the web 134, through a process such as welding or brazing or through a hardware connection, such as clamps, screws, bolds, rivets, etc. Additionally, the accessory rail 126 comprises a first side flange 138 and a second side flange 140. In some embodiments, the upper flange 130, the lower flange 132, the first side flange 138 and the second side flange 140, may be a single continuous structure. For example, and as shown in FIG. 2, a single tubular structure, such as a metal tube or a rigid polymer tube, may be formed or bent to extend along a rectangular shaped path with rounded corners to provide the upper flange 130, the lower flange 132, the first side flange 138 and the second side flange 140.

The web 134 may be formed from a metal plate or sheet and may be coupled to each flange 130, 132, 138, 140 and each bracket 136 of the accessory rail 126, such as by welding. Additionally, the web 134 may include one or more stiffening features formed therein. For example, the web 134 may include a plurality of elongated horizontal stiffening ribs 142. In other embodiments, the web 134 may be an open area defined between the flanges 130, 132, 138, 140. Support structures, such as tubular structures, rib structures, etc., may extend between the flanges 130, 132, 138, 140 through the open area of the web 134. The tubular structures may form a mesh structure in the web 134, which may be configured to provide support for the flanges 130, 132, 138, 140, and to secure the flanges 130, 132, 138, 140 to the brackets 136. The brackets 136 may also be secured directly to one or more of the flanges 130, 132, 138, 140, such as the upper flange 130 and the lower flange 130, through welding or brazing. The mesh structure in the web 134 may be configured to increase a stiffness of the accessory rail 126 and/or to provide additional interfaces for accessories to be coupled to the accessory rail 126.

Some accessory rails, such as accessory rails 122, 128, (see FIG. 1) may be formed to bend around a corner of the grill device 100. For example, the upper flange, the lower flange, and the web may be bent along a curve such that a first end of the accessory rail 122, 128 is oriented substantially perpendicular (e.g., at about a 90 degree angle) to a second end of the accessory rail 122, 128. Additionally, the upper flange and lower flange of each accessory rail 122, 124, 126, 128 may be substantially coaxially aligned with a corresponding upper flange and lower flange of at least one adjacent accessory rail 122, 124, 126, 128.

Accordingly, the accessory rail assembly 120 may provide attachment points for a variety of accessories along substantially the entire perimeter of the sides and front of the grill device 100, as will be discussed further below.

A variety of accessories may be configured for selective attachment to the accessory rail assembly 120, to provide a customizable grill having accessories selected by the user positioned in locations along the accessory rail assembly 120 selected by the user.

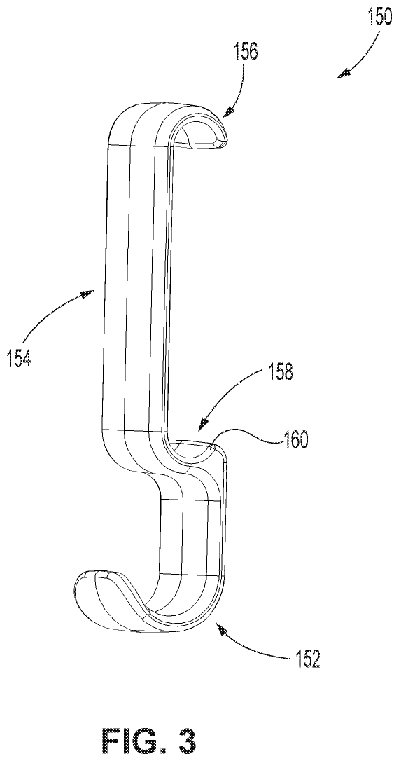

FIG. 3 shows a hook accessory 150 according to an embodiment of the present disclosure. The hook accessory 150 may be selectively attachable to the accessory rail assembly 120 (FIG. 1). The hook accessory 150 may comprise a hook 152 at a first end and an attachment structure 154 at a second end for the selective attachment of the hook accessory 150 to the accessory rail assembly 120. The attachment structure 154 may comprise an upper feature 156 sized and shaped to wrap around and conform to a portion of a surface of the upper flange 130 and a lower feature 158 sized and shaped to wrap around and conform to a portion of a surface of the lower flange 132 of an accessory rail 122, 124, 126, 128 of the accessory rail assembly 120.

To attach the hook accessory 150 to the accessory rail assembly 120, the upper feature 156 of the hook accessory 150 may be placed on the upper flange 130 of an accessory rail 122, 124, 126, 128 at a selected location. Next, the lower feature 158 may be pushed toward the lower flange 132, which may cause a protruding portion 160 of the lower feature 158 to contact the lower flange 132 and then the interaction between the protruding portion 160 and the lower flange 132 as the lower feature 158 is pushed toward the lower flange 132 may cause the attachment structure 154 to deform (e.g., to bend) allowing the lower feature 158 to be positioned over the lower flange 132. The attachment structure 154 may be resilient and return toward its original shape after the lower feature 158 is positioned on the lower flange 132, causing the surface of the lower feature 158 to contact the corresponding surface of the lower flange 132, which may retain the hook accessory 150 onto the accessory rail assembly 120 at the desired location.

The hook accessory 150 may be removed from the accessory rail assembly 120 by pulling the hook 152 away from the accessory rail assembly 120, which may cause the attachment structure 154 to deform, allowing the protruding portion 160 of the lower feature 158 to pass over the lower flange 132. The upper feature 156 of the attachment structure 154 may then be lifted up off of the upper flange 130.

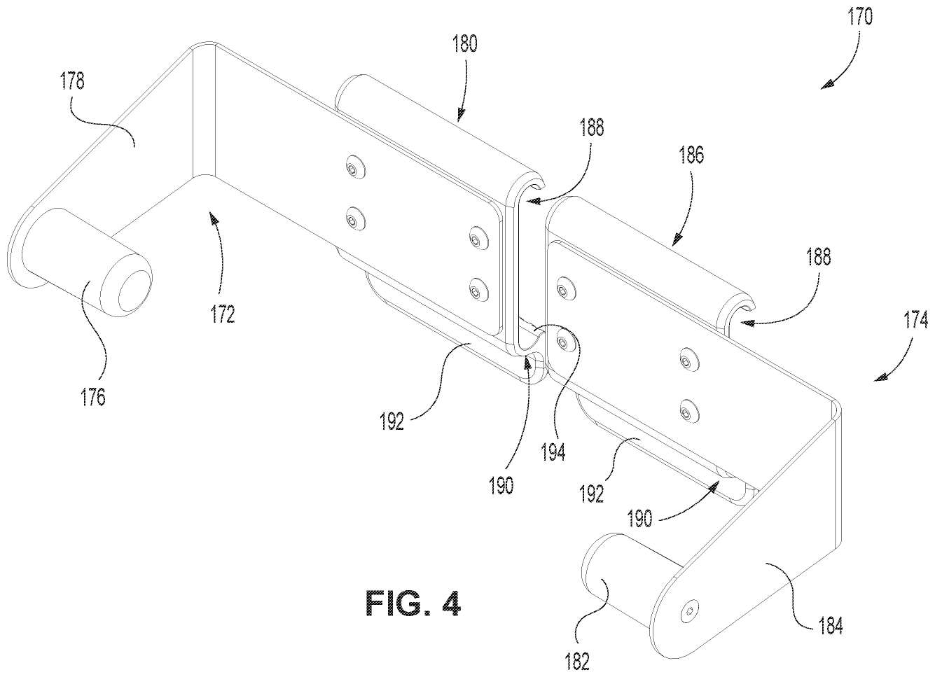

FIG. 4 shows a roll holder accessory 170 according to an embodiment of the present disclosure. The roll holder accessory 170 may include a first roll end holder 172 and a second roll end holder 174. The first roll end holder 172 may include a post 176 positioned on an arm 178, the post 176 sized an positioned to for insertion into an opening at a first end of a tube of a roll dispensed material (not shown), and the arm 178 coupled to an attachment structure 180 at for the selective attachment of the first roll end holder 172 to the accessory rail assembly 120. Similarly, the second roll end holder 174 may include a post 182 positioned on an arm 184, the post 182 sized an positioned to for insertion into an opening at a second end of a tube of a roll dispensed material, and the arm 184 coupled to an attachment structure 186 at for the selective attachment of the second roll end holder 174 to the accessory rail assembly 120. The attachment structures 180, 186 of the first roll end holder 172 and the second roll end holder 174 may be substantially identical, and may be similar to the attachment structure 154 of the hook accessory 150 (FIG. 3).

Each attachment structure 180, 186 may comprise an upper feature 188 sized and shaped to wrap around and conform to a portion of a surface of the upper flange 130 of an accessory rail 122, 124, 126, 128 and a lower feature 190 sized and shaped to wrap around and conform to a portion of a surface of the lower flange 132. Each attachment structure 180, 186 may additionally include a tab 192 extending below a protruding portion 194 on the lower feature 190.

To couple the attachment structure 180, 186 to the accessory rail assembly 120, the upper feature 188 of the attachment structure 180, 186 may be placed on the upper flange 130 of an accessory rail 122, 124, 126, 128 at a selected location. Next, the lower feature 190 may be pushed toward the lower flange 132, which may cause the protruding portion 194 of the lower feature 190 to contact the lower flange 132 and then the interaction between the protruding portion 194 and the lower flange 132 as the lower feature 190 is pushed toward the lower flange 132 may cause the attachment structure 180, 186 to deform (e.g., to bend) allowing the lower feature 190 to be positioned over the lower flange 132. The attachment structure 180, 186 may be resilient and return toward its original shape after the lower feature 190 is positioned on the lower flange 132, causing the surface of the lower feature 190 to contact the corresponding surface of the lower flange 132, and couple the attachment structure 180, 186 onto the accessory rail assembly 120 at the desired location. Accordingly, each of the first roll end holder 172 and the second roll end holder 174 may be secured to the accessory rail assembly 120 at a desired location.

To attach a roll dispensed material (e.g., paper towels, butcher paper, plastic wrap, aluminum foil, etc.) to the roll holder accessory 170, the first roll end holder 172 and the second roll end holder 174 may be spaced apart on the accessory rail assembly 120 so that the posts 176, 182 are spaced apart a distance that is greater than the length of the roll dispensed material. An opening of a first end of the roll dispensed material may be positioned over one of the post 176 of the first roll end holder 172 and the post 182 of the second roll end holder 174. Then the other of the first roll end holder 172 and the second roll end holder 174 may be slid along the accessory rail assembly 120 to insert the other post 176, 182 into an opening at a second end of the roll dispensed material to secure the roll dispensed material to the roll holder accessory 170. Likewise, one of the first roll end holder 172 and the second roll end holder 174 may be slid along the accessory rail assembly 120 away from the other to remove the roll dispensed material from the roll holder accessory 170.

Alternatively, the posts 176, 182 of each of the first roll end holder 172 and the second roll end holder 174 may be inserted into each end of the roll dispensed material, respectively, prior to attachment of the first roll end holder 172 and the second roll end holder 174 to the accessory rail assembly 120.

As the first roll end holder 172 and the second roll end holder 174 may be positioned at various distances apart on the accessory rail assembly 120, roll dispensed materials of various rolled lengths (i.e., material widths) may held by the roll holder accessory 170.

Each attachment structure 180, 186 of the roll holder accessory 170 may be removed from the accessory rail assembly 120 by pulling the respective tab 192 away from the accessory rail assembly 120, which may cause the attachment structure 180, 186 to deform allowing the protruding portion 194 of the lower feature 190 to pass over the lower flange 132. The upper feature 188 of the attachment structure 180, 186 may then be lifted up off of the upper flange 130.

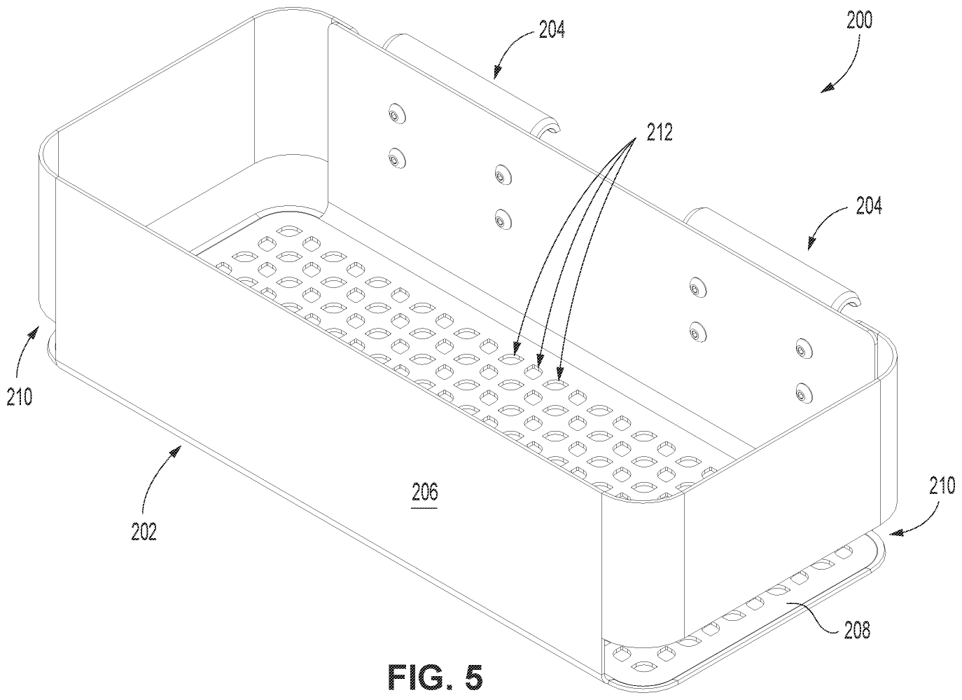

FIG. 5 shows a basket accessory 200 according to an embodiment of the present disclosure. The basket accessory 200 may include a basket 202 with at least one attachment structure 204 attached thereto. For example, the basket accessory 200 may include a basket 202 attached to two attachment structures 204. Each attachment structure 204 attached to the basket 202 may be identical to the attachment structures 180, 186 described with reference to the roll holder accessory 170 (FIG. 4), and may be attached and removed from the accessory rail assembly 120 at a desired location in the same way. In other embodiments, the attachment structures 204 may include a slot configured to extend around the accessory rail assembly 120 on both an outer side and an inner side of the accessory rail assembly 120. For example, the attachment structures 204 may include a lower feature including a protruding portion similar to the lower feature 190 of the attachment structures 180, 186 described above. The slot structure may replace the upper feature 188, such that the attachment structures 204 may substantially surround the attachment structures 204 when fully coupled to the accessory rail assembly 120. The slot structure may be positioned over the accessory rail assembly 120, such that the slot structure substantially envelops the outer side, inner side and upper flange 130. The lower feature may then be deformed as describe above, such that the protruding portion may pass over the lower flange 132. Once installed, the inner portion of the slot structure may be positioned proximate the protruding portion of the lower feature, such that the attachment structure 204 substantially surrounds the accessory rail assembly 120.

The basket 202 of the basket accessory 200 may include a sidewall 206 extending around a floor 208. There may be an opening 210 between the sidewall 206 and the floor 208 at each end of the basket 202, and the floor 208 of the basket 202 may be perforated with a plurality of openings 212 extending therethrough, which may allow materials (e.g., spices, sauces, beverages, etc.) that may be spilled in the basket 202 during use to fall through the openings 212. This may facilitate keeping the floor 208 of the basket relatively free of debris. Additionally, materials that may spill onto the floor 208 of the basket 202 that do not fall through the openings 212 may be easily swept out of the basket 202 via the openings 210. In some embodiments, the basket 202 may be formed from a sheet of metal, such as stainless steel.

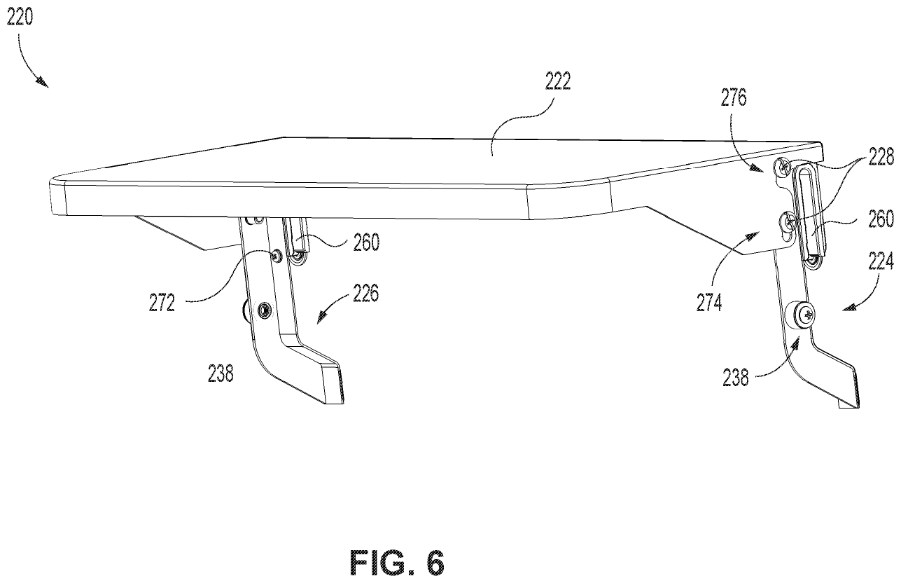

FIG. 6 shows a shelf accessory 220 according to an embodiment of the present disclosure. The shelf accessory 220 may include a shelf 222 with a first bracket 224 attached at a first end and a second bracket 226 attached at a second end, such as with fasteners 228. The first bracket 224 and the second bracket 226 may be configured to interface with the accessory rail assembly 120 to secure the shelf accessory 220 to the associated grill device 100. The connection between the shelf 222 and the brackets 224, 226 with the fasteners 228 may be configured to facilitate the shelf 222 moving between deployed and stowed positions while the shelf accessory 220 remains secured to the grill device 100 through the accessory rail assembly.

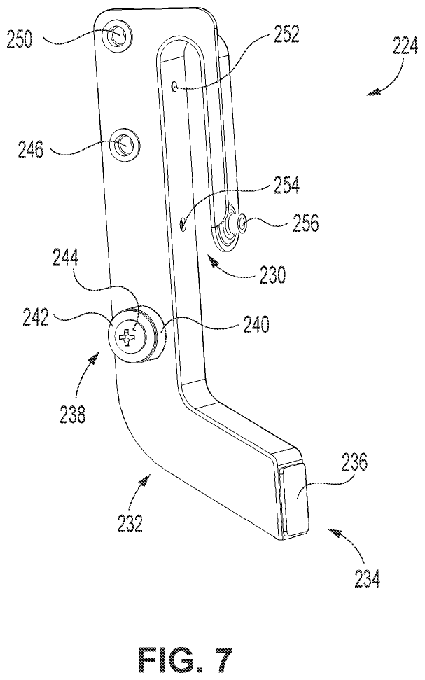

The first bracket 224 of the shelf accessory 220 is shown in FIG. 7. The second bracket 226 may be configured to have reflectional symmetry to the first bracket 224 (i.e., it may appear like a mirror image) and may otherwise be substantially identical to the first bracket 224. Each of the first bracket 224 and the second bracket 226 may include a slot 230 for attachment to the accessory rail assembly 120 and a leg 232 extending to a foot 234 positioned to rest against the cooking portion assembly 104 of the grill device 100 (FIG. 1). The slot 230 may be configured to extend around the accessory rail assembly 120 on both an outer side and an inner side of the accessory rail assembly 120. The slot 230 may be positioned over the accessory rail assembly 120, such that the slot structure substantially envelops the outer side, inner side and upper flange 130. Optionally, each foot 234 may include a foot pad 236 thereon to provide some cushioning between the foot 234 of each of the first bracket 224 and the second bracket 226 and the cooking portion assembly 104. For example, the foot pad 236 may be a resilient material that is resistant to heat, such as rubber, silicone, or cork, that is attached (e.g., adhered) to the foot 234.

A bumper 238 may be attached to a side of each of the first bracket 224 and the second bracket 226 and may provide a resilient stop for the shelf 222 when in the stowed position. For example, each bumper 238 may comprise a rubber washer 240 positioned between the side of the respective first bracket 224 and second bracket 226 and a flat washer 242 attached to a threaded portion (e.g., a rivet nut) of the bracket with a threaded fastener 244 (e.g., a screw).

A first threaded portion 246 (e.g., a rivet nut) may be located at an upper portion of the side of each of the first bracket 224 and the second bracket 226 to receive a fastener 228 (e.g., a screw) which may connect the shelf 222 to each of the first bracket 224 and the second bracket 226 and provide a pivot for the shelf 222 relative to the first bracket 224 and the second bracket 226. A second threaded portion 250 (e.g., a rivet nut) may be positioned on the side of each of the first bracket 224 and the second bracket 226 above the first threaded portion 246 and configured to receive a fastener 228 which may selectively secure the shelf 222 in a deployed position, as will be discussed in further detail herein.

The slot 230 of each of the first bracket 224 and the second bracket 226 may include a protrusion 252, an aperture 254, and a threaded portion 256 (e.g., a rivet nut), which may be utilized to secure the shelf accessory 220 to the accessory rail assembly 120.

To install the shelf accessory 220 to the accessory rail assembly 120, clips 260 may be placed on over an accessory rail assembly 120 at locations where each of the first bracket 224 and the second bracket 226 of the shelf accessory 220 are to be installed.

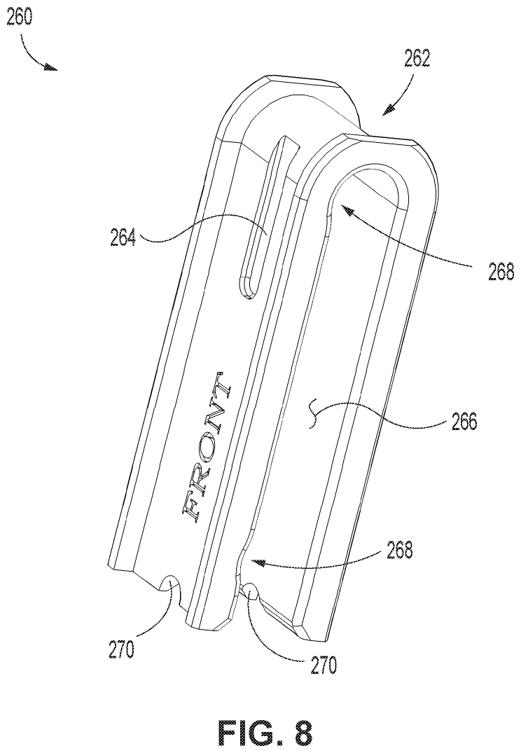

Referring now to FIG. 8, each clip 260 may be comprised of a polymer so that each clip 260 may have some flexibility and resilience. The clips 260 may be generally u-shaped with a channel 262 on an outer side thereof sized to receive the slot 230 of a corresponding first bracket 224 and second bracket 226. One side (e.g., a front side) of each clip 260 may include a recess 264 corresponding to the protrusion 252 of a corresponding bracket 224, 226. The clips 260 may additionally include an inner surface 266 that is sized to receive a portion of the accessory rail assembly 120 therein. For example, the inner surface 266 of each clip 260 may include indentations 268 sized and positioned to receive the upper flange 130 and the lower flange 132 therein, respectively. Notches 270 may be located at one end of each clip 260 to permit the passage of a threaded fastener 270 therethrough, as will be discussed in further detail herein.

After attaching the clips 260 to the accessory rail assembly 120 at locations where the brackets 224, 226 of the shelf accessory 220 are to be installed, the slots 230 of the brackets 224, 226 of the shelf accessory 220 may be placed over the clips 260, as shown in FIG. 6. It is noted that prior to installing the brackets 224, 226 onto the clips 260, the brackets 224, 226 may be attached to the shelf 222 with the fasteners 228. As the slots 230 of the brackets 224, 226 are placed over the clips 260, the protrusion 252 (FIG. 7) located on each bracket 224, 226 may enter the recess 264 (FIG. 8) of a corresponding clip 260. Accordingly, if a clip 260 were to be accidentally installed onto the accessory rail assembly 120 in an incorrect orientation (e.g., if the front of the clip 260 is positioned over the rear of the accessory rail assembly 120) the protrusion 252 may engage with an outer surface of the clip 260 and prevent, or at least hinder, the positioning of the bracket 224, 226 onto the clip 260 in the incorrect orientation.

Upon insertion of the clips 260 and underlying accessory rail assembly 120 into the slots 230 of the brackets 224, 226 of the shelf accessory 220, the shelf accessory 220 may be securely fixed to the accessory rail assembly 120 with threaded fasteners 272 (FIG. 6). A threaded fastener 272 (e.g., a screw) may secure each bracket 224, 226 to the accessory rail assembly 120 and prevent removal therefrom, without first removing the threaded fastener 272. A threaded portion of each threaded fastener 272 may be inserted through the aperture 254 of the corresponding bracket 224, 226, under the lower flange 132 (FIG. 2) of the accessory rail assembly 120, and into the threaded portion 256 of the bracket 224, 226. Tightening of the threaded fastener 272 into the threaded portion 256 may apply a compressive force to the clip 260 and accessory rail assembly 120 via the slot 230 of the bracket 224, 226, which may secure the shelf accessory 220 to the accessory rail assembly 120 and prevent any significant movement of the bracket 224, 226 relative to the accessory rail assembly 120.

After the shelf accessory 220 is secured to the accessory rail assembly 120, the shelf 222 may be selectively moved between a deployed configuration, as shown in FIG. 6, and a stowed configuration. Referring to FIG. 6, the shelf 222 may include a hinged attachment 274 to the first bracket 224 and the second bracket 226 of the shelf accessory 220. The hinged attachment 274 may allow the rotation of the shelf 222 between the deployed configuration, and the stowed configuration. The shelf 222 may additionally include a locking attachment 276 to the first bracket 224 and the second bracket 226, which may selectively lock the shelf 222 in the deployed configuration and prevent rotation of the shelf 222 about the hinged attachment 274. For example, the hinged attachment 274 may include elongated openings which may allow the shelf 222 to translate a fixed distance at the hinged attachment 274 to facilitate the engagement and disengagement of the locking attachment 276. Accordingly, when the shelf 222 is positioned in the deployed configuration, the shelf 222 may be translated downward by applying a downward force to engage the locking attachment 276 and prevent rotation of the shelf 222 about the hinged attachment 274. Likewise, when the shelf 222 is positioned in the deployed configuration, the shelf 222 may be translated upward by applying an upward force to disengage the locking attachment 276 and allow rotation of the shelf 222 about the hinged attachment 274. The hinged attachment 274 and the locking attachment 276 may be configured to interface with the fasteners 228. The fasteners 228 may be threaded fasteners, rivets, or pins extending from the brackets 224, 226.

Referring now to FIG. 1, as the accessory rail assembly 120 provides accessory rails 122, 124, 126, 128 extending along the perimeter of the front and sides of the grill device 100, accessories configured to be coupled to the accessory rail assembly 120 may be located at any of various locations on the accessory rail assembly 120. Additionally, as the accessory rails 122, 124, 126, 128 of the accessory rail assembly 120 may be aligned with adjacent accessory rails 122, 124, 126, 128 of the accessory rail assembly 120, accessories with more than one point of attachment, such as the shelf accessory 220, may be connected to a first accessory rail 122, 124, 126, 128 at a first end and an adjacent second accessory rail 122, 124, 126, 128 at a second end. Thus, a user can arrange the position of accessories along a perimeter of the grill device 100 as they desire and according to their specific cooking preferences. Additionally, accessories may be added to, removed from, and/or moved along the front and sides of the grill device 100 with ease, facilitating the reconfiguration of accessories for each specific food preparation.

It will be understood that accessories in addition to those shown in FIGS. 3-6 may be provided with an attachment structure (e.g., configured substantially like to the attachment structure 154 (FIG. 3) or the attachment structure 180 (FIG. 4)) to selectively attach each accessory to the accessory rail assembly 120, according to embodiments of the present disclosure. For example, a cooking tool (e.g., a spatula, tongs) may include an attachment structure configured substantially like to the attachment structure 154 or the attachment structure 180 attached to a handle of the cooking tool. Accordingly, the handle of the cooking tool may be selectively attached the cooking tool to the accessory rail assembly 120 with the attachment structure.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternate useful combinations of the elements described, will become apparent to those skilled in the art from the description. Such modifications and embodiments also fall within the scope of the appended claims and equivalents.

What is claimed is:

1. A grill device, comprising:
an accessory rail assembly, the accessory rail assembly comprising:
at least one accessory rail, the at least one accessory rail comprising:
an upper flange;
a lower flange;
a web extending between and connected to the upper flange and the lower flange; and
a plurality of brackets connecting the at least one accessory rail to a cooking portion assembly of the grill device.

2. The grill device of claim 1, wherein the accessory rail assembly extends along substantially an entire perimeter of a first end, a front, and a second end of the cooking portion assembly of the grill device.

3. The grill device of claim 2, wherein the cooking portion assembly of the grill device comprises a cooking chamber, a fuel chamber, and a fixed shelf.

4. The grill device of claim 1, wherein the upper flange and lower flange of the at least one accessory rail are comprised of a single tubular structure.

5. The grill device of claim 4, wherein the web is comprised of a metal plate.

6. The grill device of claim 5, wherein the web comprises at least one horizontal stiffening rib.

7. The grill device of claim 1, wherein the at least one accessory rail assembly comprises at least one accessory rail having a first portion extending along at least a portion of the front of the grill device and a second portion extending along at least a portion of one of the first side and the second side of the grill device.

8. An accessory for a grill device, the accessory comprising:
at least one attachment structure, the at least one attachment structure comprising:
an upper feature sized and shaped to wrap around and conform to a portion of a surface of an upper flange of an accessory rail of a grill device; and
a lower feature sized and shaped to wrap around and conform to a portion of a surface of a lower flange of the accessory rail.

9. The accessory of claim 8, wherein the at least one attachment structure further comprises a tab extending below a protrusion on the lower feature, the tab configured to facilitate the removal of the at least one attachment structure from the accessory rail.

10. The accessory of claim 8, wherein the at least one attachment structure comprises a first attachment structure and a second attachment structure; and wherein the accessory further comprises:
a first roll end holder coupled to the first attachment structure; and
a second roll end holder coupled to the second attachment structure.

11. The accessory of claim 8, the accessory further comprising a cooking tool having a handle, the handle attached to the at least one attachment structure.

12. The accessory of claim 8, the accessory further comprising a hook extending from the at least one attachment structure.

13. The accessory of claim 8, the accessory further comprising a basket, the basket comprising a sidewall and a floor, the sidewall attached to the at least one attachment structure.

14. The accessory of claim 13, further comprising at least one opening between the floor and the sidewall of the basket.

15. The accessory of claim 14, wherein the floor of the basket is perforated.

16. A shelf accessory for a grill device, the shelf accessory comprising:
a shelf;
a first bracket comprising a slot sized and configured for attachment to an accessory rail assembly of a grill device and a leg extending to a foot located and configured to rest against a cooking portion assembly of the grill device, the first bracket coupled to a first end of the shelf; and
a second bracket comprising a slot sized and configured for attachment to an accessory rail assembly of a grill device and a leg extending to a foot located and configured to rest against a cooking portion assembly of the grill device, the second bracket coupled to a second end of the shelf.

17. The shelf accessory of claim 16, wherein the shelf is coupled to the first bracket and the second bracket with hinged attachments, and configured to rotate relative to the first bracket and the second bracket between a stowed position to a deployed position.

18. The shelf accessory of claim 16, further comprising:
a first foot pad positioned on the foot of the first bracket; and
a second foot pad positioned on the foot of the second bracket.

19. The shelf accessory of claim 18, further comprising:
a first polymer clip positioned within the slot of the first bracket; and
a second polymer clip positioned within the slot of the second bracket.

20. The shelf accessory of claim 19, further comprising:
a first threaded fastener located below the first polymer clip; and
a second threaded fastener located below the second polymer clip; and
wherein the first threaded fastener and the second threaded fastener are positioned and configured to prevent removal of the shelf accessory when installed on the accessory rail of the grill device.
